(19) United States
(12) Patent Application Publication
(10) Pub. No.: US 2004/0145235 A1
(43) Pub. Date: Jul. 29, 2004

(54) Wheel cover for making a tire look thinner

(75) Inventor: Ming Fang Wang, Tainan Hsien (TW)

Correspondence Address: BACON & THOMAS, PLLC, 625 SLATERS LANE, FOURTH FLOOR, ALEXANDRIA, VA, 22314

(73) Assignee: Kuan Hsings Enterprise Corp., Tainan Hsien (TW)

(21) Appl. No.: 10/349,969

(22) Filed: Jan. 24, 2003

(51) Int. Cl. B60B 7/00

(52) U.S. Cl. 301/37.101

(57) ABSTRACT

In the present invention, an edge is extended from the rim of a circular disc of a wheel cover, and such edge is the portion that the circular disc of the wheel cover exceeds the rim of the steel wheel, having an appropriated width to sufficiently block the thickness of the tire and make the tire look thinner.

### BACKGROUND OF THE INVENTION

1. Field of the Invention

This invention relates to a wheel cover making tires look thinner, more particularly to a wheel cover having a simple structure that can be installed onto a steel wheel and make a tire look thinner.

2. Description of the Related Art

In FIG. 1, a traditional wheel cover 1 is basically comprised of a circular disc 11; a plurality of engraved holes 12 in special shapes disposed on the circular disc 11; a plurality of latch members 13 equidistantly disposed on the backside of the wheel cover 1, each latch member 13 at its ends has a groove 14, such that the grooves 14 of the latch members 13 define an area for surrounding and supporting a steel ring 15, and the periphery of the area defined by the latch members 13 and propped by the steel ring 15 is embedded into the steel wheel 2.

The main purpose of such design of the prior art is to cover up the bad looking wheel 2. Therefore, the structure of the circular disc 11 is usually designed in a way that the external rim is exactly equal to or slightly smaller than the rim of the external ring edge 21, which can only accomplish the purpose of covering the steel wheel 2.

However, the motor vehicles nowadays are no longer used for transportation only, and the installation of the steel wheel on the tire is not just for rotation only. Many drivers usually change the original 13-inch wheels to 14-inch wheels or the 14-inch wheels to 15-inch wheels. The main purpose is to increase the traveling mileage under the same rotary speed; since the area under the chassis and tire is very limited, the tire cannot be changed to a larger size unlimitedly. Therefore, the wheel size is increased under allowable horsepower and torque conditions of the motor vehicle. If the external diameter of the pattern section of the tire is constant, then the thickness of the tire becomes relatively smaller. Many drivers are interested in thinner wheels. However, such hope for a thinner tire cannot be realized because the factory default horsepower and torque requirements do not allow the change for a larger steel wheel unless the car is rebuilt. Thus, it is not easy to realize the hope for a thinner wheel.

### SUMMARY OF THE INVENTION

The objective of this invention is to provide an improved wheel cover comprises a circular disc disposed on the wheel cover; a plurality of engraved holes in special shapes disposed on the circular disc; a plurality of latch members disposed on backside of the wheel cover; an edge is extended from the rim of a circular disc of a wheel cover, and such edge is the portion that the circular disc of the wheel cover exceeds the rim of the steel wheel, having an appropriated width to sufficiently block the thickness of the tire and make the tire look thinner.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1 is a cross-sectional diagram of a prior art wheel cover being installed onto a wheel.

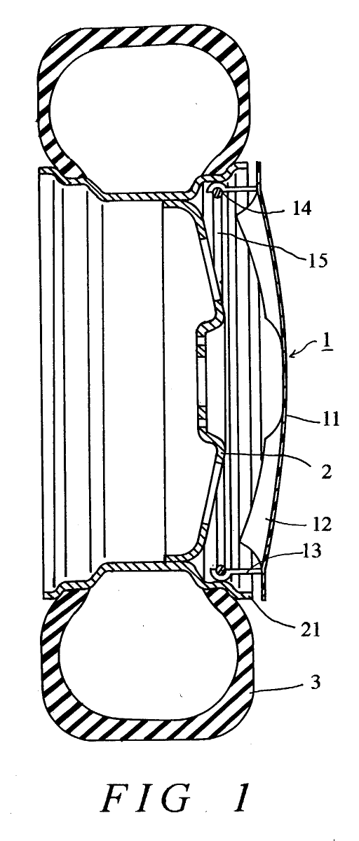

FIG. 2 is a cross-sectional diagram of an accessory ring being installed onto a wheel in accordance with the wheel cover of a preferred embodiment of the present invention.

### DETAILED DESCRIPTION OF THE PREFERRED EMBODIMENTS

In the detailed description of the preferred embodiments, it should be noted that like elements are indicated by the same reference numerals throughout the disclosure.

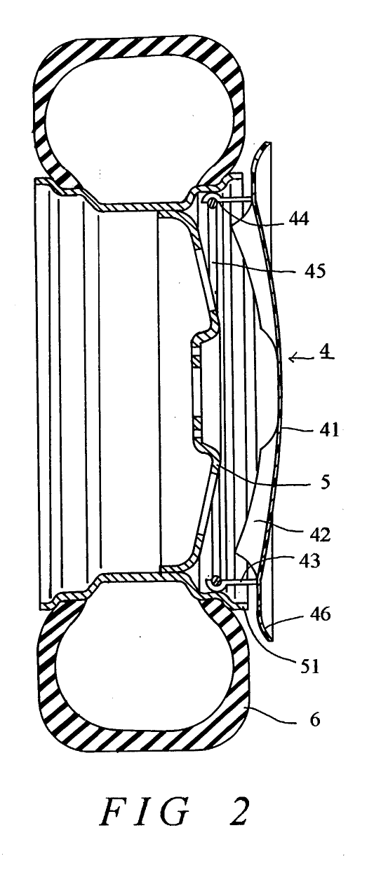

Please refer to FIG. 2 for the wheel cover in accordance with a preferred embodiment of the present invention that comprises a circular disc 41 disposed on a wheel cover 4; a plurality of engraved holes 42 in special shapes disposed on the circular disc 41; a plurality of latch members 43 equidistantly disposed on the backside of the wheel cover 4, each latch member 43 at one end has a groove 44, and the groove 44 of each latch member 43 encloses an area with a periphery to embed a steel ring 45; and makes use of the periphery enclosed by the latch members 43 and propped by the steel ring 45 to embed a steel wheel 5.

An edge 46 is extended from the rim of a circular disc 41, and such edge 46 is the portion that the circular disc 41 of the wheel cover 4 exceeds the rim 21 of the steel wheel 5, having an appropriated width to sufficiently block the thickness of the tire 6 on the steel wheel 5 and make the tire look thinner. The edge 46 forms a slightly lifted arc such that the edge 46 can keep an appropriate safe distance from the tire 6, and such distance can tolerate a range even under the condition of a flat tire. However, the shape is not limited to the lifted arc only.

The present invention has a simple structure, and saves the trouble of replacing different wheels to make the wheel look thinner for drivers. In addition, the present invention has little impact on the wheel cover structure and cost of the mold, but the effect of making the tire look thinner are definite and practical.

While the present invention has been described in connection with what is considered the most practical and preferred embodiment, it is understood that the invention is not limited to the disclosed embodiments but is intended to cover various arrangements included within the spirit and scope of the broadest interpretation and equivalent arrangements.

What is claimed is:

1. A wheel cover making tires look thinner, comprising of a circular disc; a plurality of engraved holes in special shapes disposed on the circular disc; a plurality of latch members disposed on backside of the wheel cover; and the wheel cover making use of the latch members to enclose an area with a periphery to embed a steel wheel; characterized in that an edge is extended from the rim of a circular disc of a wheel cover, and such edge is a portion that the circular disc of the wheel cover exceeds the rim of the steel wheel, having an appropriated width to sufficiently block the thickness of the tire and make the tire look thinner.

2. A wheel cover making tires look thinner as claimed in claim 1, wherein said edge is slightly lifted outward.
